(19) United States
(12) Patent Application Publication
(10) Pub. No.: US 2003/0219019 A1
(43) Pub. Date: Nov. 27, 2003

(54) Method of inverse multiplexing/demultiplexing dynamically fluctuating ATM cell streams

(76) Inventor: Tyler James Wilson, Anaheim, CA (US)

Correspondence Address: Tyler Wilson, 2859 West Rome Avenue, Anaheim, CA, 92804, US

(21) Appl. No.: 10/153,778

(22) Filed: May 24, 2002

(51) Int. Cl. H04L 12/28; H04J 3/24

(52) U.S. Cl. 370/395.1; 370/395.6; 370/394; 370/474

(57) ABSTRACT

A method of inverse multiplexing and demultiplexing multiple ATM communication channels. This process is intended to maximize the use of bandwidth on all channels when the bandwidth conditions on each channel are fluctuating dynamically with time. In extreme cases, this method is intended to work even when one or more channels cease to operate. The multiplexing part of this method seeks to maximize the bandwidth along all communication links as well as maintaining a record of the bandwidth fluctuations along the channels. The demultiplexing part of this method seeks to accurately reconstruct the ATM cell stream that was inverse multiplexed across the multiple communication links by ordering the cells in the same order as they were sent. Two processes are presented by which this is done.

### BACKGROUND OF THE INVENTION

Asynchronous Transfer Mode (ATM) is a protocol designed for high-speed digital communication. Information in ATM networks is transferred using packets 53 bytes long. 44 bytes of the packet comprise the payload which the packet carries. 4 bytes of the packet may optionally be used to transmit information for the ATM adaptation layer. The header of the packet is 5 bytes long and contains information used to: route the packet to its destination, describe the payload type of the packet, and describe the priority of the the packet.

The ATM protocol was created because it's predecessor “synchronous transfer mode” (STM) was found to be inefficient when transferring data with different QoS requirements. In STM, time is divided into a series of slots which are then grouped together into a frame that repeats in time. One can think of a railroad engine pulling a train of rail cars (the time slots) from the source to the destination—over and over again. STM is inefficient because it transfers data along a circuit between the source and destination continuously regardless of whether the user needs to receive the data or not.

ATM networks use statistical multiplexing to provide bandwidth when required for users. This is when multiplexing decisions are made based on the calculated probability of user need. Of course the network resources can still become overloaded even using these new algorithms, which would decrease performance for all users. To keep channels from becoming overloaded—users agree to “traffic contracts” which guarantees a minimum QoS for the user as well as controlling user demands on network resources.

QoS stands for Quality of Service and refers to the ability of a network to provide higher selective service over different technologies such as Frame Relay, ATM, 802.1 and Ethernet networks, as well as SONET and IP-routed networks that may also make use of these technologies. As an example—someone who is using a network to watch a live streaming rock concert video in real-time is going to have different network needs than someone who is downloading the latest version of their favorite MP3 player.

In the first case—if one out of every hundred packets does not get routed correctly to the destination resulting in a missing frame of the video feed—this will hardly be detectable to the user. However, if there is substantial network lag—this will result in a noticeable degradation in quality of the video feed. In networking terms—this is a delay sensitive application. Losing things occasionally is considered acceptable. Delay is not.

In the second case—if one packet is misplaced or not delivered in the same sequence it was transmitted in, the entire binary file is corrupted and will need to be downloaded again. On the other hand, the user is probably not overly concerned with the download taking slightly longer because of network lags—but does expect that once the file has been downloaded, it will be undamaged. This is termed a loss sensitive application of the network.

The ATM protocol implements different QoS requirements through information transmitted in the header of each ATM packet. In particular—ATM routers scan the VPI number (Virtual Path Identifier), VCI number (Virtual Channel Identifier), payload type, and cell loss priority. Combined, the VPI/NCI numbers together form a Virtual Circuit. This circuit is determined at the start of a connection (either through call set-up rules or by assignment). Additionally, the ATM header also provides flow control and header error control (so the receiver can determine if a packet payload was damaged en route to its destination, or not routed correctly). Once a Virtual Circuit (VPI/NCI) has been established between a transmitter and a receiver on a network, all cells on this circuit follow the same path through the network. Users of an ATM network send ATM cells to an ATM interface—where the cells are placed in a queue and await assignment and transmission. One unique feature of the ATM protocol is that cells are received in the same order in which they are sent (although there is nothing in the ATM header which will indicate the order in which a cell was placed within a cell transmission queue).

ATM networks respond to the threat of network overloading by coming to an agreement with the network users of the type of traffic they typically use (called a “traffic contract”). This is what the network uses to manage and allocate network resources (such as bandwidth consumed and buffer loads). It is also used to observe user traffic patterns and whether or not they are in compliance with the contract that was agreed to.

The ATM protocol is used by a vast variety of communication technologies as a common language for instantiating communications links in an environment in which the network bandwidth is treated as a shared resource allocated on an as-needed basis. Links which use the ATM protocol to pass information typically include T1 lines in North America (1.544 Mbs), E1 lines in Europe (2.048 Mbs), SDSL (2.048 Mbs), T2 lines (6.312 Mbs), the European equivalent—E2 (8.448 Mbs). More exotic varieties also include high speed optical links such as SDHISONET OC-3 lines (155.52 Mbs), OC-12 (622.08 Mbs), OC-24 (1.244 Gbps), OC48 (2.488 Gbps), OC-192 (10 Gbps), and OC-255 (13.21 Gbps). The optical links are usually used for high-speed Internet backbone applications where lower-speed T1, T2 links branch off to connect to them.

The need for the present invention arose from a desire to provide modular bandwidth solutions to users of ATM networks at rates between traditional ATM hierarchies (ie. between T1/E1 and T3/E3 levels in traditional communications hierarchies). A user's network requirements may be such that a T3/E3 solution is prohibitively expensive and far exceeds the demands placed on the network, while a T1/E1 solution does not provide enough bandwidth to fulfill the needs of a growing network.

Into this gap a number of different Inverse Multiplexing for ATM (IMA) schemes have been proposed U.S. Pat. Nos. 5,608,733 and 5,617,417 and the ATM Forums, “Inverse Multiplexing for ATM (IMA) Specification”, Version 1.0, July 1997—the contents of which are herein referenced.

All of these different ATM inverse multiplexers seek to aggregate multiple T1/E1 communication links to give the user higher bandwidth rates which can be increased and decreased in a modular fashion as the needs of the ATM network evolves.

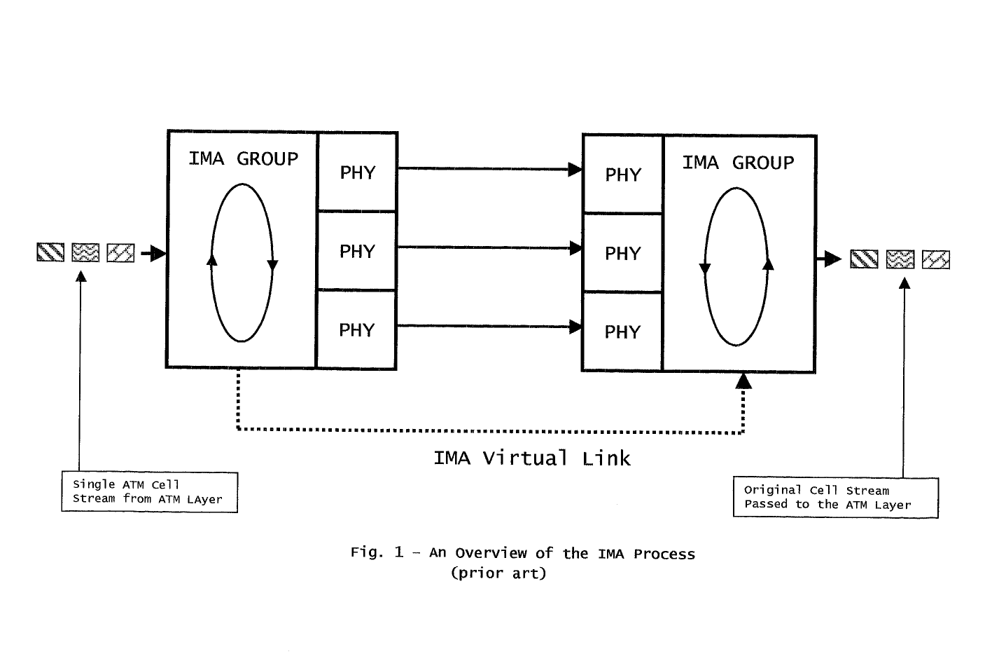

The implementation described in “Inverse Multiplexing for ATM (IMA) Specification, Version 1.0” will be the one referenced here. FIG. 1 illustrates this implementation.

The purpose of IMA is to inverse multiplex an ATM cell stream across multiple physical links and to reconstruct the original cell stream at the far end of these links. The multiplexing of the ATM cell stream is performed on a cell by cell basis

The IMA Group terminates at each end of the IMA Virtual Link (FIG. 1). In the transmit direction—ATM cells are distributed in a round-robin fashion among the links within the IMA Group. In the receiving direction—the original cell stream is reconstructed in a similar round-robin fashion. The cells in the reconstructed cell stream must be in the same order as the cells in the original ATM cell stream.

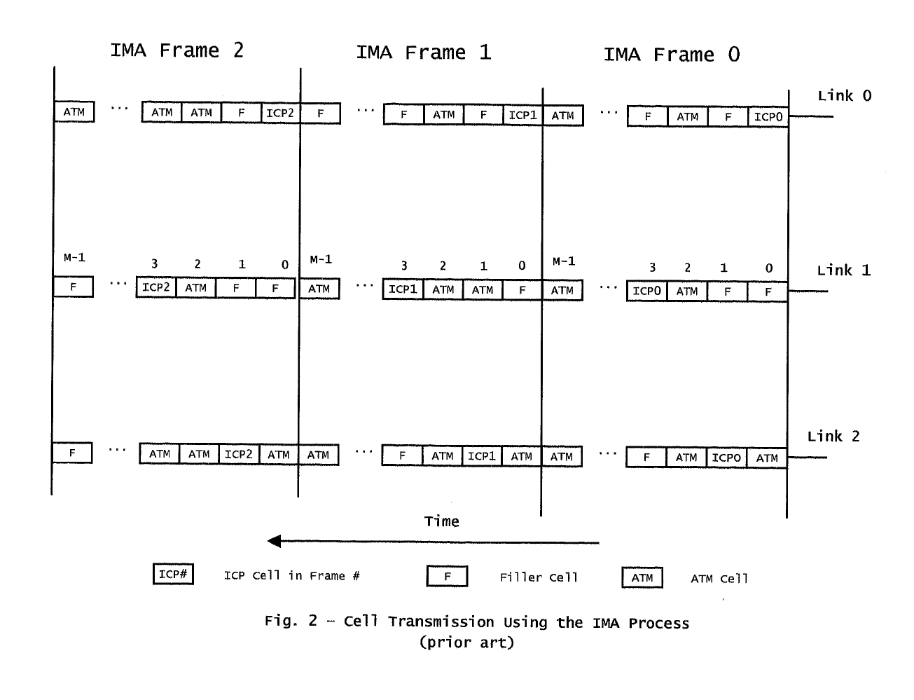

To accomplish this the IMA group periodically transmits special cells on each link that permit accurate reconstruction of the original cell stream. These cells are referred to as IMA Control Protocol (ICP) cells. ICP cells define IMA frames. The transmitter must align the transmission of IMA frames on all links. This will allow the receiver to adjust for any differential link delays on any of the links. This makes it possible for the receiver to detect any differential delays by waiting for the IMA frames on each link. This situation is depicted in FIG. 2. When the transmitter is not transmitting ATM cells, it is transmitting filler cells to maintain a continuous stream of cells at the physical layer. Filler cells are discarded by the receiver when it reconstructs the cell stream.

Both ICP cells and filler cells are a special new class of cell created to handle transmission of information across an IMA virtual link. OAM (Operation Administration and Maintenance) cells contain a special code which tells the receiver whether or not it is a filler cell, or an ICP cell.

ICP cells define individual IMA frames—and the transmitter must transmit ICP cells on all physical links (see FIG. 2). The ICP cells can be placed anywhere within an IMA frame, and all ICP cells contain a number which indicates their distance in cells from the start of the transmission queue (called the cell offset). In FIG. 2, the ICP cell on link 1 of frame 2 has a cell offset of 0, the second ICP on link 1 has a cell offset of 2, and the ICP cell on link 3 of frame 2 has a cell offset of 1.

Very recently with the advent of xDSL technologies (referring to the different flavors of current Digital Subscriber Line technologies available now—such as ADSL, VDSL, SDSL, HDSL to name a few), xDSL communications links have become important components within ATM networks as information carriers. These technologies are based on making use of advanced compression algorithms to send data in the upper frequency spectrum of standard phone lines. Because the data being sent has a higher frequency than normal, low-frequency voice signals—it is susceptible to a wide variety of influences which can degrade or corrupt the signal. These include—but are not limited to: (1) the condition of the phone lines themselves (such as bridged taps), (2) network topologies, (3) stray electromagnetic fields from the Sun (solar flares), as well as man-made fields from amateur radio enthusiasts/airports/military communications. All of these factors combine to degrade the quality of a DSL signal the farther it has to travel over a normal phone line. By plotting the strength of a DSL signal relative to its distance from where it originated (the CO—Central Office where the DSL signal originates), it can be seen that this strength decreases as a linear function of the distance from the CO.

A number of complications arise with the use of xDSL technologies when applied to conventional ATM Inverse Multiplexing. This is because in the conventional case, it is assumed that all physical links comprising an IMA Virtual Link have equal data capacities, and that this capacity does not fluctuate with time. Conventional ATM Inverse Multiplexers are only equipped to handle one type of physical link which has a constant transmission delay rate. A typical example would be a T1 link which transmits ATM cells in a 193 bit frame (actually 192 bits plus one framing bit) every 125 milliseconds. In conventional multiplexing techniques, additional delay is added to some links so that the cell delay shall be the same across all links.

In xDSL communication links—the data capacity as well as the transmission delay can vary widely as a function of time. In some cases, a communication link may drop out of the IMA Group altogether. Conventional Inverse ATM Multiplexers are ill-equipped to handle this situation.

They would handle the problem by reducing the speed of all links to that of the slowest link, thus dramatically decreasing the pool of available bandwidth. And this is when the bandwidths across all links are different but constant with time. A bandwidth fluctuation on a link between one transmission cycle and the next would result in that link being dropped from the IMA Group.

To handle fluctuating bandwidth conditions, alternative ATM Inverse Multiplexers have been proposed (U.S. Pat. No. 6,222,858 B1). Two methods are presented within this patent to handle fluctuating bandwidth conditions (“the simple k” method and the “variable Q” method). In the “simple k” method, each communication link numbered from 1.N is serviced in each round robin cycle by exactly k(i) cells. This contrasts with conventional inverse multiplexing where each flow is serviced on a cell-by-cell basis each cycle. The number k(i) can be thought of as representing the bandwidth on the link. Clearly for synchronization to take place, the transmitter and the receiver will have to have the same ordered list of channel LIDs (sorted in order of k values). Then reconstruction of the ATM cell stream proceeds by servicing the flow with the lowest cell rate first, followed by flow with the next highest, and so on. Or the stream could be reconstructed by servicing the flows in order from highest k-value to lowest.

The “simple k” method works reasonably well provided the cell rates across the different links are not changing from one round-robin cycle to the next, and provided that the cell rates of all channels are integer multiples of one other. If either of these two conditions is not met, a high degree of latency will result and the algorithm will degrade in performance.

In the “variable q” method, the number of cells enqueued on each link is allowed to vary from cycle to cycle, in response to fluctuating bandwidth conditions. This works even better than the “simple k” method under conditions which may be termed more realistic. On each round-robin cycle, q(i,n) cells are transmitted on each channel i. The number n refers to the number of the current cycle. The q values for each cycle can be thought of as the bandwidth value for that channel on the current cycle. To reconstruct the ATM cell stream on the receiving end—the q values must somehow be communicated from the transmit end to the receiving end. Since the q-values on each of 1.N links of an IMA group are changing with each round-robin cycle, clearly a large number need to be transmitted within an IMA frame to permit accurate reconstruction on the receiving end. There is no mention within the patent of how this information is communicated.

One can assume that it would require the creation of new data structures such as ICP cells—in a way extending the protocol envisioned in “Inverse Multiplexing for ATM (IMA) Specification Version 1.0”. Or it could mean using the empty fields within filler cells to transmit the q-values. This would amount to the same thing however—since a field would have to be added to the filler cell marking it as a structure that was storing q-values for a channel so that the receiver would not discard the cell. Or it could require setting aside one link (or reserving partial bandwidth on a link) for the transmission of q-values.

It should also be noted that both the “variable q” and “simple k” methods assume that retrieving an accurate estimate of a communication links available bandwidth is always going to be available with the framework in which the algorithms function.

Because the IMA specification has been widely applied at this point in hardware and software related to inverse multiplexing and demultiplexing ATM cell streams with much success, a need clearly exists for a new method that can both work within the framework of this specification, yet handle the situations enumerated above. A method which requires a bare minimum of additional maintenance data being sent from the transmitting end to the receiving end of the IMA group, while still maximizing the available bandwidth on all links. It would also be helpful if this method could keep some record of the fluctuating bandwidth conditions across the physical links of the IMA Group.

### SUMMARY OF THE INVENTION

This invention provides the following:

1. A way to reliably multiplex and demultiplex multiple ATM channel streams when the channel capacity of the respective channels is changing as a function of time,

2. The bandwidth across all links needs to be maximized,

3. This history of bandwidth fluctuations needs to be recorded.

4. The algorithm will continue to work even when one or more channels goes down.

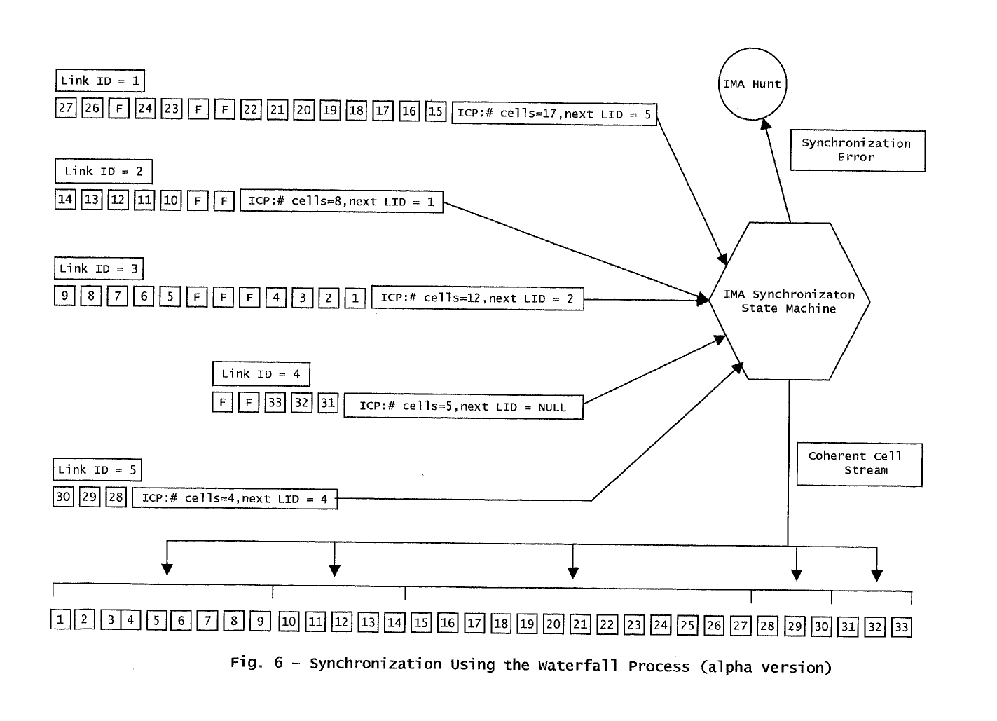

Two algorithms are described herein which accomplish these objectives. They are identical in all respects except in how they handle the synchronization of the multiple cell streams on the receiving end. The Waterfall process—alpha version (described below and in FIG. 6) relies upon byte 50 of the ICP cell to transmit synchronization information from the transmit end to the receiving end (as detailed in Reference 2—p.31). Modified filler cells could also potentially service this purpose. The Waterfall process—beta version is not reliant upon this byte or any additional information being sent that is not mentioned in the original IMA specification (Reference 2). Although this makes synchronization more complex, it also means that the second method is not reliant upon a specification detail which could be changed in future implementations.

### DESCRIPTION OF THE DIAGRAMS

FIG. 1—An overview of the IMA process (prior art)

FIG. 2—Cell transmission using the IMA process (prior art)

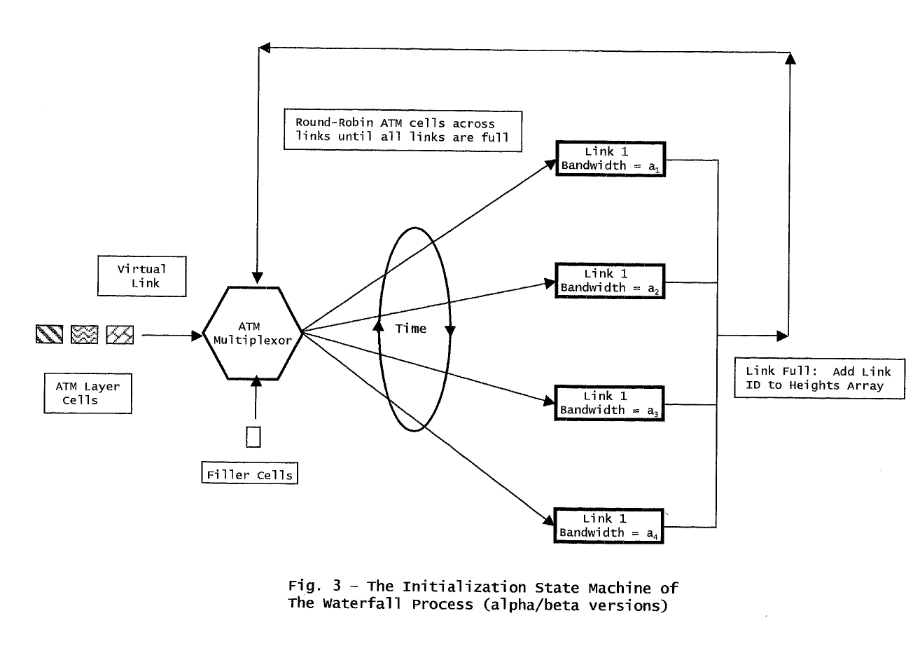

FIG. 3—The Initialization State Machine of the Waterfall process (alpha/beta versions)

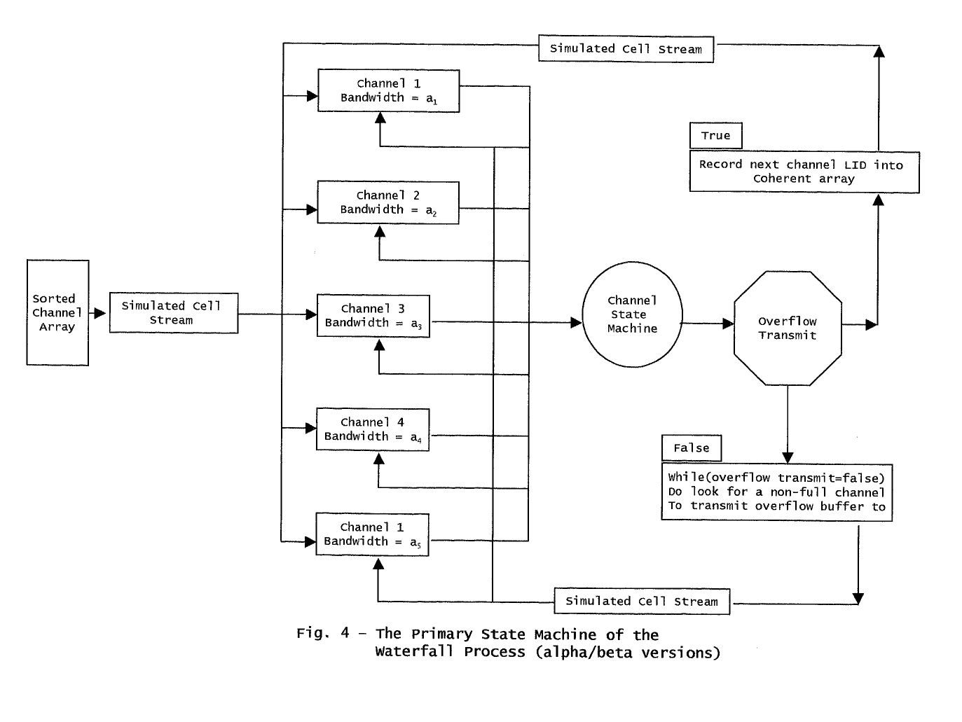

FIG. 4—The Primary State Machine of the Waterfall process (alpha/beta versions).

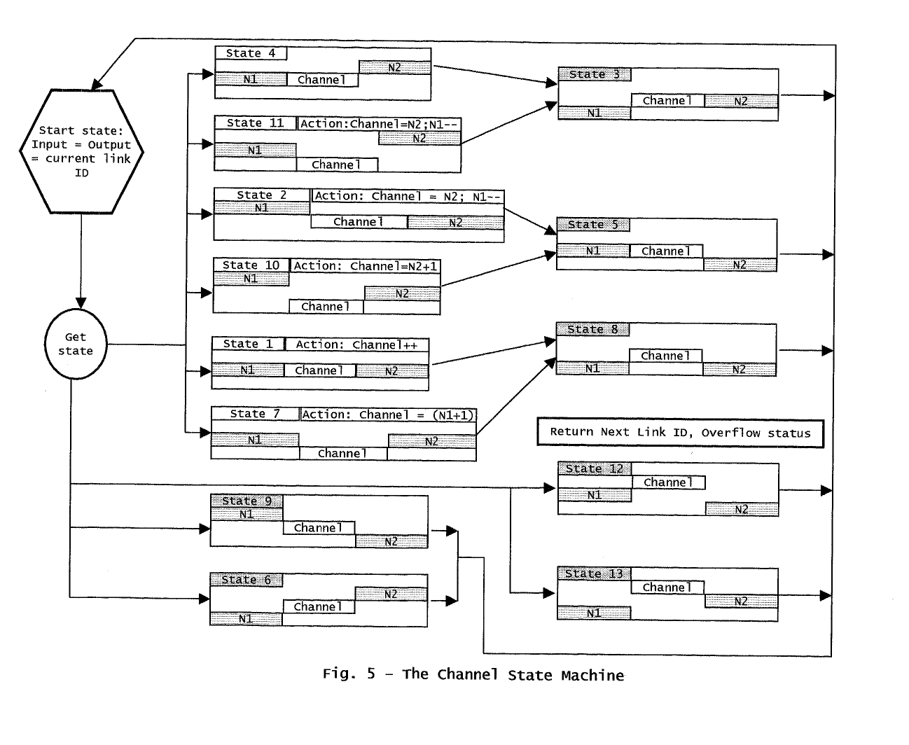

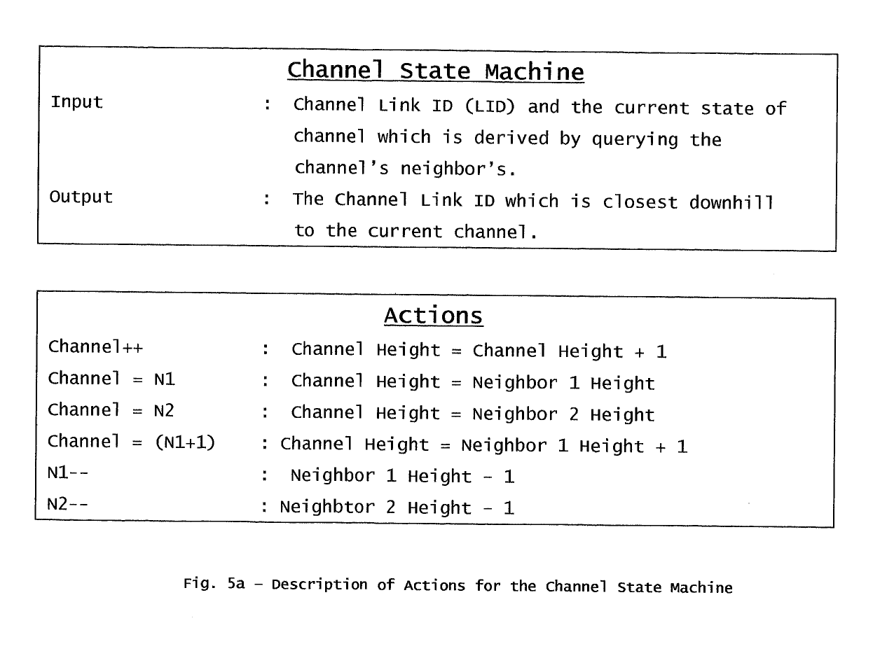

FIG. 5—The Channel State Machine of the Waterfall process (alpha/beta versions).

FIG. 5a—Description of Actions for the Channel State Machine

FIG. 6—Synchronization using the Waterfall process (alpha version)

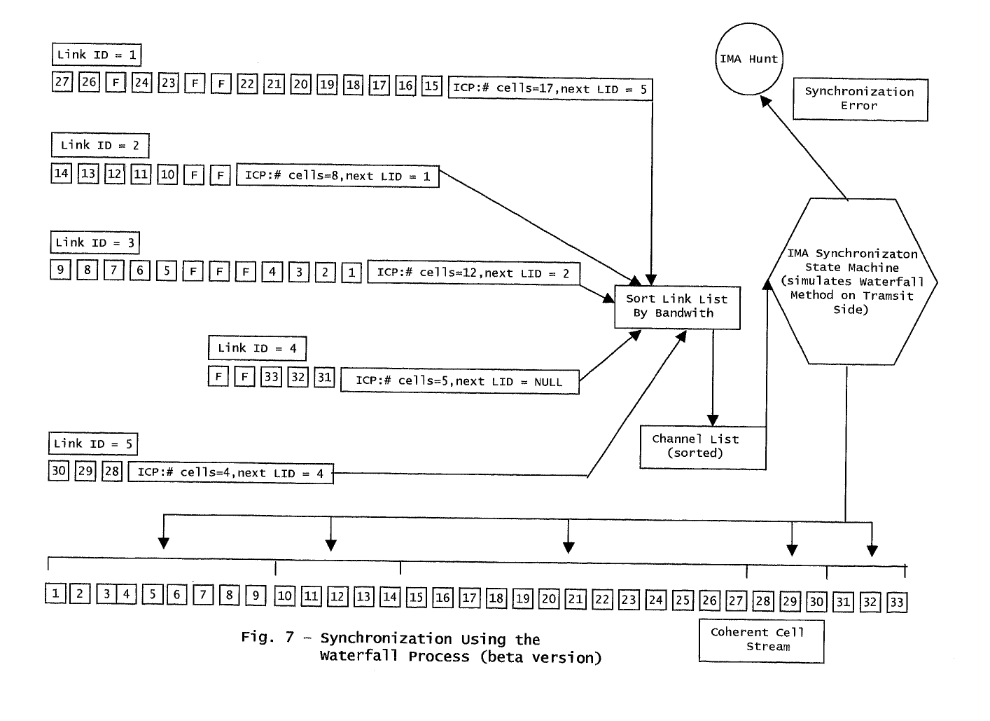

FIG. 7—Synchronization using the Waterfall process (beta version)

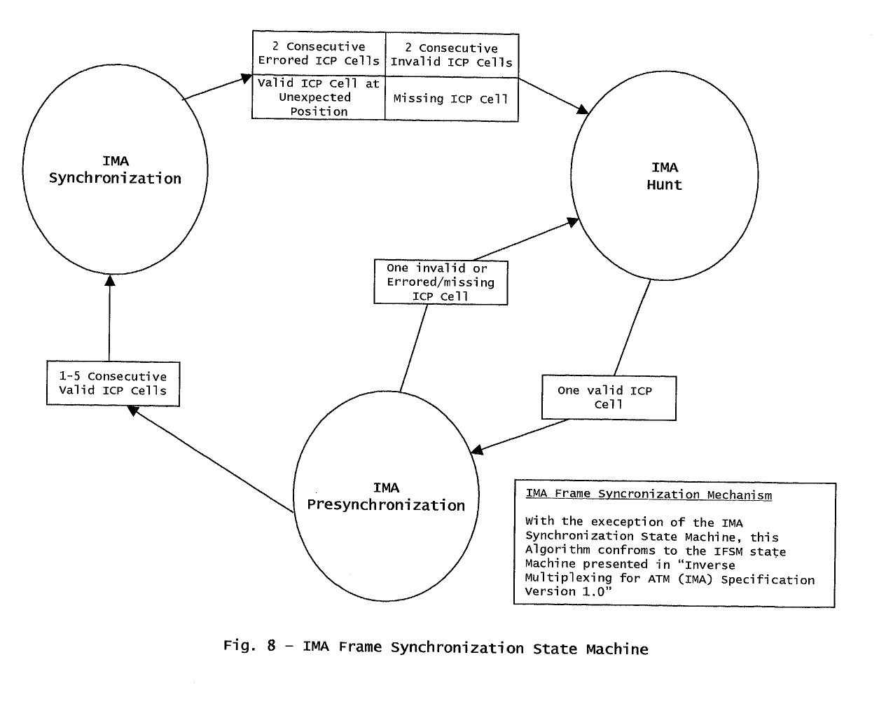

FIG. 8—IMA Frame Synchronization State Machine

### PHYSICAL ANALOGY

The algorithm will demultiplex the cells across the communication links in such a way that the bandwidth usage on each channel will be maximized. It achieves this ideal state by modeling a physical analogy between water flow across pipes (transmission channels), and ATM cell flow. Imagine that you have a large pipe filled to capacity which is transmitting water at the rate of A m³/s downhill to five smaller pipes with capacities a₁, a₂, a₃, a₄, and a₅ such that A=a₁+a₂+a₃+a₄+a₅. Further imagine that each pipe has a sink attached to it, and when the channel starts to overflow, it transmits the overflow to this sink. The sink then pumps the excess downhill. If the pipe is downhill of other pipes that are not filled to capacity, its height will be raised so that it is higher than either of its neighbors, and will push the excess flow to the neighbor closest to its own height. This continues until all of the water from the main pipe has flown through all of the tributary pipes.

It seems obvious when discussing water moving through pipes that the flow through the tributary pipes should be maximal. The only strange part of the algorithm is why the heights must change with time, to achieve this maximal condition. To extend the analogy, think of fluctuating bandwidth conditions as pipes whose diameters shrink and grow dynamically with time.

Departures from the Physical Analogy

It is necessary to clarify points at which this algorithm departs from the physical model it is based on (water flowing through pipes). The obvious ways in which the analogy departs from the physical reality (shrinking and expanding of the pipe cross-sections as being representing fluctuating bandwidth conditions—and the heights of the pipes constantly changing in time in response to this) have already been stated.

Each channel is able to communicate with both of its neighbors immediately adjacent to it. That is—each channel can ask of its neighbor what its current height is, and whether or not it is capable of accepting more ATM cells. It can transmit and receive ATM cells from its neighbors based on these values. This is based upon “Utopia Level 1—Version 2.01” (Reference 3) which defines the interface between the Physical Layer (PHY) and upper layer modules such as the ATM layer and other various management entities such as IMA. This is the primary mechanism by which the algorithm flexibly adopts to changes in bandwidth across the channel-space. The algorithm should be viewed not from a global point-of-view (as some master finite state machine allocating cells across the channel-space). It should be viewed locally from the point of view of each channel responding to events in its immediate neighborhood and acting in accordance to a few simple rules (see FIG. 5).

A Detailed Description of the Preferred Embodiment of this Method

A full description for this algorithm involves six finite state machines—the ISM (initialization state machine), the PSM (Primary State Machine), CSM (Channel State Machine), the IMA Synchronization State Machine (both alpha and beta versions), and the IFSM (IMA Frame Synchronization State Machine).

The Initialization State Machine (FIG. 3) is called only once, on the first transmission cycle after the IMA group has been instantiated. On initialization—the ATM cell stream is inverse multiplexed in a round-robin fashion across the channel links comprising the IMA virtual link. When a channel is filled to capacity, the Channel LID (a number that uniquely identifies the channel) is inserted into the Heights list (an array of integers). Consequently, the channel LIDs near the front of the Heights list have lower bandwidths than the ones near the end, and the index into the list for each Channel LID is used to give each channel an initial Height value.

Primary State Machine

After the first transmission cycle, when the heights array has been initialized, the Primary State Machine (FIG. 7) is the main super state machine for this algorithm. There are four phases to the Primary State Machine:

1. N ICP cells (for the N channels comprising the IMA Group) are round-robined across the channel space (so there is an ICP cell at the head of each channel).

2. The starting channel receives the N×(M−1) cells of the current IMA frame until it is saturated, at which point the cells are added to the channels' reservoir buffer (a linked list). It does not matter which channel receives the cell stream first.

3. The channel calls the Channel State Machine (FIG. 4). THE CSM is aware of the height of the current channel, and of the channels' neighbors. Based on this knowledge, it broadcasts the overflow of the current channel to one of the channel neighbors.

4. There is the possibility that one or both of the channels' neighbors may also be full. In this case, the overflow would be transmitted to the reservoir buffer of a neighboring channel, and so on. This continues until an open channel is found to which the overflow can be broadcast. If synchronization on the receiving end is using the alpha version of the Waterfall process, the ICP cells (inserted during step 1 above), need to have the next Channel LID fields set. This is byte 50 of the ICP cell (which is currently unused—see Reference 1). For synchronization purposes to be explained later, the Channel State Machine returns a data structure to the PSM that contains two values:

1). The next Channel LID (an integer value).

2) A boolean value which answers the question: Did this channel absorb any part of the overflow? If yes, this field is set to true. If no—this field is set to false.

If the overflow was partially or wholly absorbed by a neighbor channel, the ICP channel of the current channel has byte 50 set to the LID of the channel the overflow was transmitted to.

If the overflow was not absorbed at all by the neighbor, but instead handed off to another channel, the Primary State Machine enters a loop. During this loop no ICP cells are set until the overflow is finally absorbed by a channel.

Channel State Machine

The channel state machine is where the algorithm is actually implemented. There are 13 different states a channel can be in with respect to the height of its neighbor channels.

That is, given a channel with neighbor's n₁ and n₂, there are three different possible positions that the height of n₁ can be in which respect to the height of the channel. It can be higher than than the channel, on the same level as the channel, or at a lower height than the channel. The same is true for channel n₂. So there are 3×3=9 different possible relationships for n₁ and n₂ to be in with respect to the channel. In addition to this, if the channel is higher than both n₁ and n₂, we must contend with 3 additional states. The state were n₁>n₂, n₂>n₁, and n₁=n₂. And finally there is the case when all of the channels are equal in height. This results in 9+3+1=13 different states.

The input to the Channel State Machine is the channel LID. The LID (Link ID), is a number that uniquely identifies the channel. If the Channel LID=s (which is the index into an array of channels numbered from 0 to n−1 for n channels), the the LID for neighbor 1 is (s−1)mod n, and the LID for neighbor 2 is (s+1) mod n. Once the CSM reaches a final state (states numbered 3, 5, 6, 8, 9, 12, 13), then the machine is ready to return the channel LID for either neighbor 1 or neighbor 2 (depending on which channel is downhill from the current channel).

It may happen that the channel that we need to transmit from is within a valley. There are six different actions a channel can take at this point (see FIG. 5a). A simple heuristic can be applied at this point to remember these actions:

The height of a channel will increase until it is one level above at least one of its neighbors and can send it's overflow ‘downhill.’

The channel that the CSM returns to the PSM is the channel that the input channel will transmit its overflow buffer to.

IMA Synchronization State Machine (Alpha Method)

This state machine conforms with once exception to the IFSM State Machine presented in Reference 2 (see FIG. 8). The one exception is the IMA Synchronization phase of the IFSM (which has been replaced with an alternative state machine (see FIG. 6).

During the synchronization phase—any ATM inverse multiplexer must be able to recombine the ATM cells distributed across the multiple communications links in exactly the same order they were sent. This presents something of a problem since the cells are not numbered before they are sent across. In conventional ATM multiplexors (ones where the bandwidth on all communication lengths is the same and does not fluctuate), the ICP cells are used to transmit information which permits accurate and reliable reconstruction of this ATM cell stream.

In inverse multiplexers designed to cope with links where the bandwidth fluctuates with time (U.S. Pat. No. 6,222,858 B1) this is accomplished by sending information from the transmit end to the receiving end (in the case of the above patent—values representing the bandwidth values on the transmit side are sent to the receiver).

Because the inverse multiplexing for ATM specification (Reference 2) has been implemented and used with much success—the need clearly exists for an algorithm which works within the scope of this specification that can handle dynamically fluctuating bandwidth conditions. That is—an algorithm which does not require the this protocol to be changed to accommodate it (as for an example the addition of a new cell to transmit bandwidth information from the transmit end to the receiving end).

In the alpha method—we use bytes 9 and 50 of the ICP cell. The ICP cells are the first cells transmitted onto the channel space at the start of a transmission sequence. They exist at the head of each channel queue—and give the Synchronization State Machine the information it needs to reconstruct a synchronized ATM cell stream.

Byte 9 is the cell offset. This tells the synchronizer how many ATM cells on the channel exist (both filler and non-filler cells), before it can expect another ICP cell. This byte performs the same function in this algorithm as it does in Reference 1. Byte 50—which is unused—contains the LID of the next channel the synchronizer needs to grab cells from to maintain a coherent ATM cell stream.

The synchronizer looks at byte 9 and begins to count cells until it is at the end of the channel. It then looks at byte 50 to get the next channel LID and goes to that channel, and so on until all channels within the sequence have been serviced and the current IMA frame has been demultiplexed and assembled correctly (FIG. 6).

Alternatively—this information could be transmitted within filler cells. Since bytes 8-51 of a filler cell are unused (see Reference 2—p. 27)—one byte could be used to designate that cell as a special cell containing additional synchronization information so the transmitter would not discard it upon receipt. Any one of the other bytes could be used to carry the next channel LID.

IMA Synchronization State Machine—Beta Method

Although the alpha method of synchronization is simple to implement, it has the following drawbacks:

1. It relies upon byte 50 of an ICP cell to convey crucial data about the cell distribution from the transmitter to the receiver. This works so long as that byte remains unused in future updates of the specification (Reference 2). It could also rely upon defining a new filler cell to carry this information.

2. Other software/hardware applications maybe have a need for using byte 50 as well (or if filler cells are being used to transmit synchronization data—other applications might have a different use for these cells) which Could potentially interfere with the data being sent.

Clearly there is a need for an inverse multiplexing algorithm that avoids the pitfalls enumerated above.

Like the alpha method—the beta method conforms to the IFSM State Machine of FIG. 8, with the exception of its IMA Synchronization phase (FIG. 7).

The beta method functions by maintaining two lists (the channel list and the coherent list). It recreates the demultiplexing of cells on the receiving side using the Waterfall method to recover the cell stream in the order in which it was originally sent.

When the receiver receives the first ICP cell of a new IMA frame, it queries all channels in the channel space and asks them how many cells each channel can carry. This is easy to do because the Waterfall process makes sure that the first cell at the head of each channel is an ICP cell. Finding the number of cells on each channel is simply a matter of looking at byte 9 of each ICP cell at the head of each channel. The channel LIDs are then inserted into the channel list. The channel list is sorted according to the bandwidth capacity of each channel—with the smaller channels near the front of the list and the larger ones near the end. It is intended that the channel list on the receiving end should be a duplicate of the heights list on the transmit end at this point.

The channel list is then passed to the Channel State Machine. The channel list plays the role of the IMA Group on the transmit side of the IMA virtual link. An ATM cell stream is simulated and passed to the Channel State Machine. The channel state machine distributes the simulated cells across the channel space in the same way the actual cells were distributed across the real channel space on the transmit side. As cells are added to channels, the order in which the channels are filled is recorded in the coherent list (starting with the first channel on which the ICP cell for the new IMA frame was received).

After the simulation has completed, the channel LIDs are read from the coherent list in the order in which they were inserted (from first node to last node—see FIG. 7). The cells from the respective channels are then combined to form a synchronized cell stream.

What is claimed:

1. A system for inverse multiplexing and demultiplexing for ATM, comprising:
receiving a plurality of cells from an ATM layer;
passing this plurality to an ATM IMA sublayer;
assigning individual ATM cells to two more more cell flows to construct IMA frames;
said plurality of ATM cells is passed to the ATM layer on the receiving side;
said plurality is reconstructed and passed to the ATM layer on the receiving side in the same sequential order as it was received on the transmit side of the IMA Group;

2. The system of claim 1 wherein:
the cell rate of at least one cell flow is different from at least one other cell flow of the said plurality and the cell rates are not changing from transmission cycle to transmission cycle;

3. The system of claim 1 wherein:
the cell rate of at least one cell flow is different from at least one other cell flow of the said plurality and the cell rates are changing from transmission cycle to transmission cycle.

4. The system of claim 1 wherein
At least one member of the said plurality of cells flows is dropped from the IMA Group.

5. The system of claim 1 wherein:
A list of flow IDs is maintained—sorted in order of increasing bandwidth—such that this list is updated at the end of each transmission cycle

6. The system of claim 1 wherein:
the maximal cell flow rate on each channel is achieved using the Channel State Machine of FIG. 5.

7. The system of claim 1 wherein:
cells are demultiplexed on the receiving end using information contained within byte 50 of the ICP cell defined in “Inverse Multiplexing for ATM (IMA) Specification Version 1.0” (Reference 2);

8. The system of claim 1 wherein:
cells are demultiplexed on the receiving end using synchronization information contained within a specially modified OAM Filler cell defined in “Inverse Multiplexing for ATM (IMA) Specification Version 1.0” (Reference 2);

9. The system of claim 1 wherein:
cells are demultiplexed on the receiving end by simulating the ATM cell plurality on the transmit end as input to the Channel State Machine of FIG. 5.
